(19) United States
(12) Patent Application Publication
(10) Pub. No.: US 2005/0226597 A1
(43) Pub. Date: Oct. 13, 2005

(54) Processing systems and methods of controlling same

(76) Inventors: Chris Cobb, Fresno, CA (US); Douglas B. Robinson, City Hollis, NE (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/815,031

(22) Filed: Mar. 30, 2004

(51) Int. Cl. H04N 5/76

(52) U.S. Cl. 386/52; 386/55

(57) ABSTRACT

The described embodiments relate to processing systems and methods. One exemplary method walks a source version object base, and maintains state and access to elements that appear to have been removed from the source version object base.

### BACKGROUND

Software development can involve multiple developers and/or groups of developers working on various aspects of a software product. Changes made by the developers can result in new versions corresponding to the evolution of the software product. These versions can be associated with directories and files relating to various components of the software product.

Source control management (SCM) products attempt to track and coordinate the work of the developers in creating new versions of the software product. Various SCM products, such as ClearCase®, are available to aid in basic source control management. SCM products can work in conjunction with a software development methodology to create a record of activity related to the software product. The SCM products may also limit access to specific versions of the software to prevent multiple parties from simultaneously making changes to a given version of any file or directory element that comprises the software product.

Software development tends not be a linear progression from beginning to completion, but instead tends to be more reminiscent of a tree where multiple branches develop from a central trunk or branch and the branches themselves tend to branch again. For purposes of explanation, SCM products can be described in association with this metaphorical developmental or versioning tree, which is distinct and separate from the file system directory tree. A version tree can comprise some or all of the directories and/or files associated with a given component of the software product. In such an analogy, SCM products can preserve data associated with versions of components of the software product. A given component begins with a central branch or trunk comprising a directory. A given version begins with a central branch or trunk comprising versions of files and directories in the file system. New versions associated with a given directory produce additional branching of both the version tree and the file system directory tree. Such a configuration can represent the recursive development process associated with a software product since directory versions located on an external or secondary portion of a version branch are inherently derived from, and subsequent to, a directory version located on a central or primary portion of the version branch.

In the ClearCase®/UNIX environment a file system directory tree can comprise a version object base (VOB). A VOB is a single database of elements. Starting at a root element of version zero, which can correspond to the base of the metaphorical trunk or main branch, each branch in the version tree can correspond to a new directory in the file system tree.

SCM products can attempt to manage the development process utilizing tools that control access to various versions and track the development of new versions. For example, ClearCase can provide version control through “check-in”/“check-out” features for versions corresponding to a given file or directory element. The check-out feature allows a version to be checked-out and operated upon by a single developer at a time and can prevent multiple different developers from simultaneously making changes to the same version. When the individual completes his changes to the version, two options are available. He can check-in the version which creates a new version incorporating the changes and produces a branch. Alternately, he can uncheck-out the version which deletes the changes and maintains the prechecked-out condition.

### BRIEF DESCRIPTION OF THE DRAWINGS

The same numbers are used throughout the drawings to reference like features and components wherever feasible.

FIG. 1 represents a system diagram that illustrates various components of an exemplary processing system in accordance with one embodiment.

FIGS. 2-3 illustrate an exemplary process in accordance with one embodiment.

FIGS. 4a-4b illustrate a flow diagram of process steps in accordance with one exemplary embodiment.

FIG. 5 represents a block diagram of a computing device which can support an exemplary processing system in accordance with one embodiment.

### DETAILED DESCRIPTION

OVERVIEW

The following relates to methods and processes of software source control management. Particular exemplary methods and processes can operate in conjunction with the ClearCase® SCM product to achieve greater functionality.

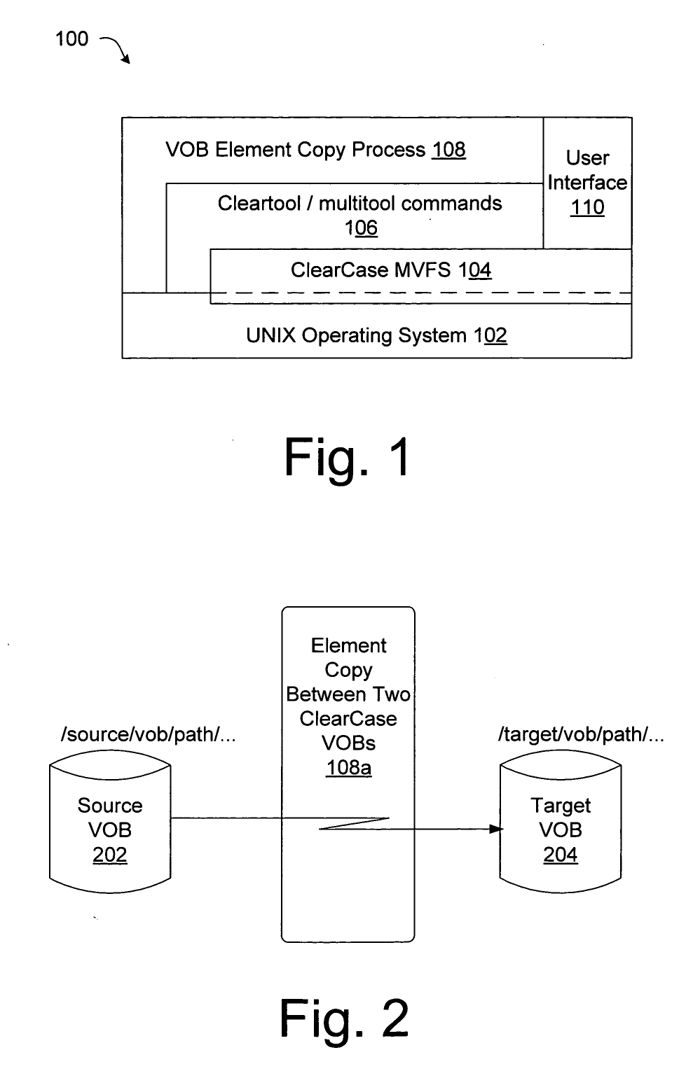

FIG. 1 illustrates an exemplary component configuration of one exemplary processing system 100. In this embodiment processing system 100 comprises a UNIX operating system 102 supporting a source control management (SCM) tool such as ClearCase® multi version file system (MVFS) 104. UNIX operating system 102 and ClearCase® MVFS 104 support one or more Cleartool/multitool commands 106. The Cleartool and multitool commands are the user interface used to manipulate the ClearCase® system (e.g., check-out, check-in).

A VOB element copy process 108 can be functionally enabled in conjunction with the underlying Cleartool commands 106. Such a configuration can provide increased functionality by load-balancing elements across multiple views thereby increasing overall system performance as evidenced at user interface 110. A View is a mechanism in ClearCase that provides the scratch pad or working area for changes to be made while an element is in a checked-out state.

As one aspect of their functionality, some SCM products establish and use element identification numbers (El ID) for each unique directory element as the directory element is encountered. In some circumstances a directory element having the same El ID may be encountered multiple times in a directory. In subsequent encounters to the El ID, a “hard-link” may be formed to the previous occurrence rather than redundantly recording the element where it is subsequently encountered. A hard-link is an operating system mechanism whereby a single file may seem to appear in more than one directory. In an SCM system, a directory hard-link may exist whereby a single directory may seem to appear in more than one parent directory, but only one instance of that directory may appear in any particular version of the software product. Otherwise, if a given directory element appeared in more than one parent directory, the underlying operating system would be in an inconsistent state.

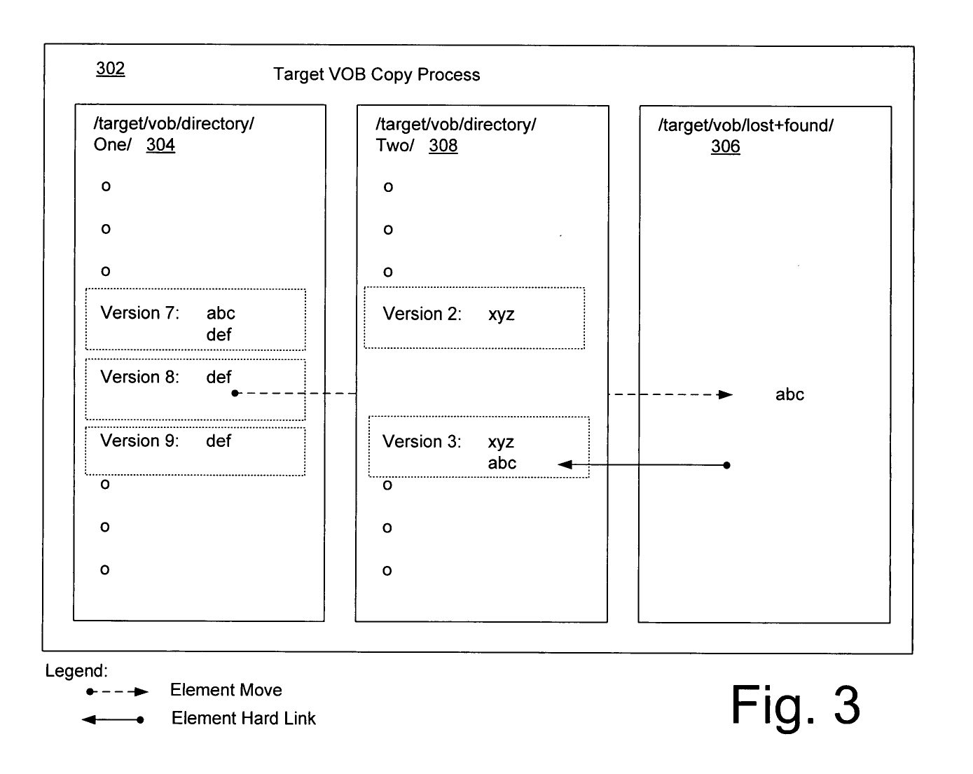

FIG. 2 illustrates a representative diagram illustrating one functional aspect of at least some of the present embodiments. This particular functional aspect relates to a VOB element copy process 108a. In this particular instance a source VOB, designated in part as “/source/vob/path/”, is indicated generally at 202 and can be copied to a target VOB indicated generally at 204 and designated in part as “/target/vob/path/”. In some exemplary processes, the copy process replicates in the target VOB 204 some or all of the data that currently exists in the source VOB 202. One particular aspect of the copy process may involve creating or establishing hard-links in the target VOB that correspond to hard-links in the source VOB.

One facet of the copy process is that an element, and/or a hard-link to an element, which appears in a particular version of a first VOB subdirectory may not appear in a subsequent version or versions. Traditionally such an element might be unavailable for copying into a second VOB subdirectory when the element and/or a hard-link to the element is subsequently encountered for copying. Examples for avoiding such scenarios are described below.

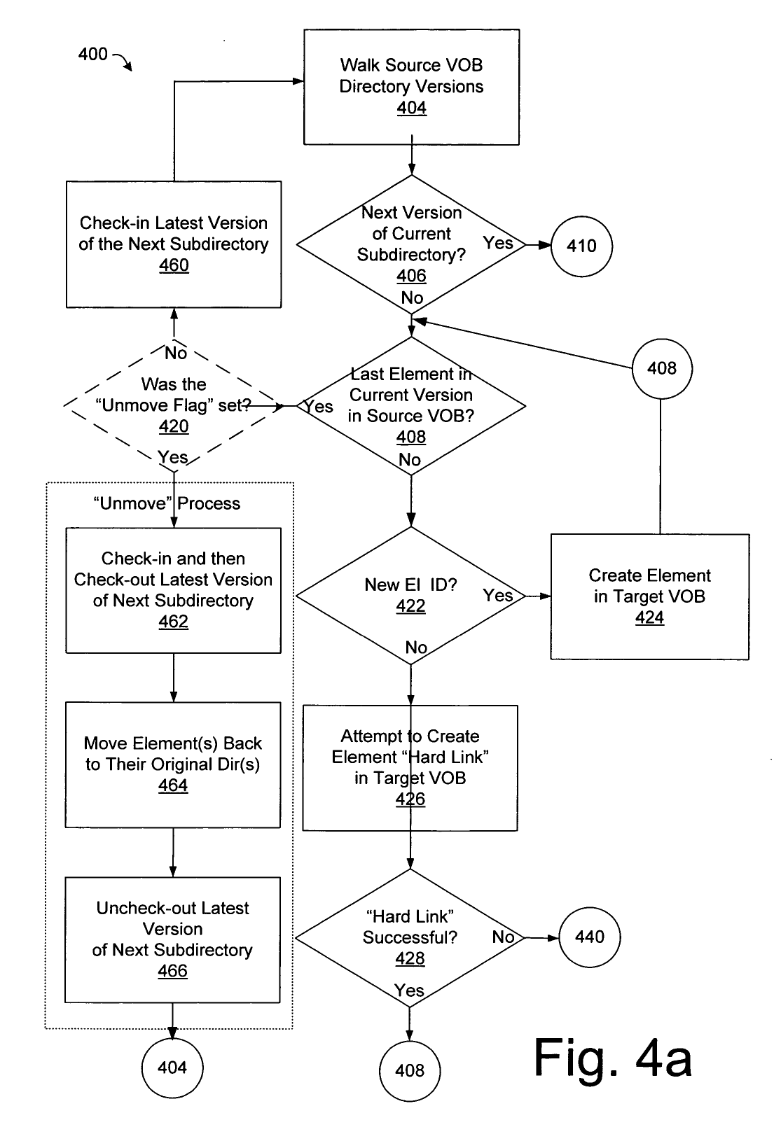

FIG. 3 illustrates an example of a processing scenario which can move elements within a directory structure in accordance with an exemplary VOB element copy process. FIG. 3 contains various versions associated with a version string. No significance is implied with the names of the various versions described herein. FIG. 3 illustrates an exemplary target VOB copying process indicated generally at 302. This exemplary process can move an element from a first target directory indicated generally as “directory/one” 304 to a special use target directory. In this embodiment the special use target directory comprises the lost+found directory 306.

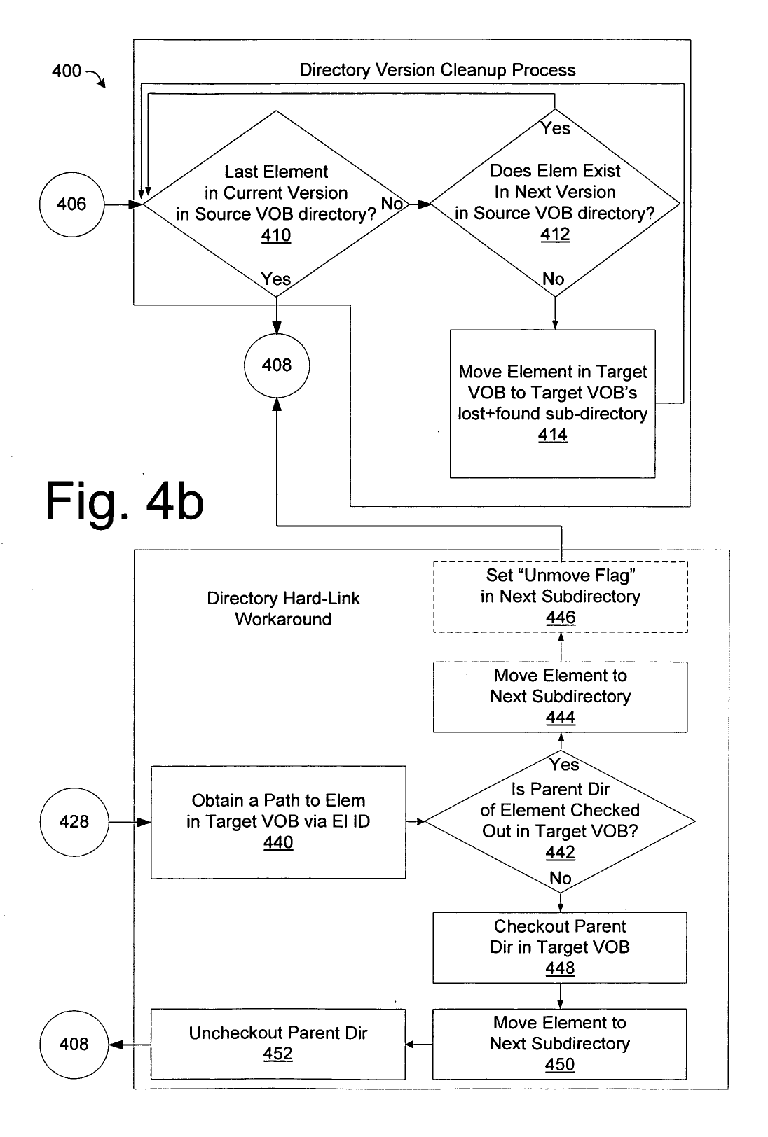

Moving the element to the special use target directory can maintain state and access to the element so that a corresponding hard-link can be formed. In this example, the second target directory can comprise “directory two” indicated generally at 308. Further, in this example, version 7 of directory/one 304 contains representative elements “abc” and “def”. Version 8 of the directory/one contains “def” but not “abc”. This exemplary process can move element “abc” to lost+found directory 306. Placing “abc” in lost+found directory 306 can maintain state and access so that when the process arrives at version 3 of directory/two 308, an element/hard-link “abc” can be established. In this instance the hard-link can be established from lost+found directory 306 to version 3 of directory/two 308. A more detailed description of this process is provided below in relation to FIG. 4.

FIGS. 4a-4b illustrate a flow diagram generally at 400 that describes one method for replicating or recreating contents of a source or first VOB in a target or second VOB. One aspect of replicating the source VOB into the target VOB can involve creating directory element “hard-links” in the target VOB that correspond to hard-links in the source VOB. The present inventors have discovered that in many situations ClearCase® commands would deny this operation and prevent completion of the target VOB. This exemplary method can maintain at least one “visible” path to an element deleted from any given subdirectory version. Maintaining the visible path can allow hard-links to be formed in the target VOB which correspond to hard-links in the source VOB.

Step 404 walks or examines source VOB directory versions. This particular method migrates elements from the source VOB to the target VOB as well as any metadata associated with the elements.

Step 406 determines whether a next element to be processed will be a new version of the current subdirectory. If the next element will not be a new version of the current sub-directory, then the process proceeds to step 408. If the element will be a new version of the current subdirectory then the process proceeds to step 410.

Steps 410, 412 and 414 can comprise a directory clean-up process which can avoid duplicating elements and/or hard-links in the target VOB while maintaining access to each of the elements/hard-links.

At step 410 the process compares elements in the current version of the source VOB directory to the elements in the next version of the source VOB directory. The process determines if the elements of the current version and next version have been compared to the point of reaching the last element in the current version. If yes, then this sub-routine is complete as to the current version and the examination is directed over to step 408. If no, then the last element has not been reached and the process proceeds to step 412.

Step 412 queries whether the present element exists in the next version in the source VOB. If yes, then the method returns to step 410. If no, then the method proceeds to move the element from the target VOB to a temporary holding directory within the target VOB at step 414. Moving the element to the temporary holding directory can ensure at least one “visible” link if the element is removed from the next sub-directory. In this instance the temporary holding directory comprises the target VOB's lost+found directory. As such, moving the element to the target VOB's lost+found directory can maintain access to the element should access be needed at a subsequent step. Upon completing step 414 the process returns to step 410.

Step 408 determines when the last element in the current source VOB directory is reached. If the last element has been reached, the process proceeds to step 420 which is discussed below. If the last element has not been reached then the process proceeds to step 422. At step 408, a condition where the last element has not been reached indicates there are additional elements in the source VOB subdirectory that have not been processed yet.

At step 422 the process queries whether a new element identification number (El ID) has been encountered. If a new El ID has been encountered the process proceeds to step 424 which creates a new corresponding element in the target VOB. The newly created target VOB element is essentially identical to the source VOB element with the exception that the target VOB element will receive its own unique El ID. A reference table of El IDs can be utilized to cross-reference these two elements. From step 424 the process returns to step 408. If at step 422 a new El ID has not been encountered the process proceeds to step 426.

Steps 426-452 illustrate a method of forming hard-links in the target VOB so that the target VOB corresponds to the source VOB. Step 426 attempts to create an element “hard-link” in the target VOB. Step 428 queries whether the hard-link was successfully created. If the hard-link was successfully created then the process proceeds to step 408. If the hard-link was unsuccessful the process proceeds to step 440.

Steps 440-452 provide an example of a directory hard-link forming method in situations where ClearCase® would not otherwise allow a hard-link to be formed (corresponding to the ‘no’ branch from step 428).

Step 440 obtains a path to the element in the target VOB via the El ID. Step 442 queries whether the parent directory of the element is checked-out in the target VOB. If so, then the parent may still be being processed. If the parent directory is checked-out, then the method proceeds to step 444. Steps 444 and 446 are discussed below. If the parent directory containing the link is not checked-out then the method proceeds to step 448. If the parent directory is not checked-out, that may indicate that the parent is not in the current branch or tree and is instead in a portion of a different branch or tree for which the copy process may have already been completed.

Step 448 checks-out the element's parent directory in the target VOB. Checking-out the parent enables that directory to be modified. Step 450 moves the element to the next sub-directory establishing a hard link. The move makes the element visible in the next subdirectory version. Step 452 can un-check-out the parent directory so that the changes to the parent are not accepted and the parent remains as it was prior to step 448.

The reader is now referred to the instance where the parent directory is checked-out at step 442. In such an instance the parent directory of the element is checked-out in the target VOB so that the method proceeds to step 444. Step 444 moves the element from the checked-out parent to the next sub-directory upon which the method is currently operating. This move, if left permanently, would change the parent directory. Step 446 sets an “unmove flag” in the object representing the parent directory. The method works recursively downward to finish the latest versions first and then works back up the branch. Flagging the parent directory provides a reminder to revisit the parent as the method works back up the branch. At this point the method returns to step 408.

If step 408 indicates that the current version and the next version match, the method proceeds to 420 as described above. At step 420 the method determines whether the “unmove flag” is set. If the unmove flag is not set the method can check-in the next version at 460. The entire process can then be repeated starting at step 404 except that the next version, because of the check-in process, will now be considered the current version for comparison sake. If the “unmove flag” is set then step 420 directs the method to step 462.

Steps 462-466 represent steps for finishing processing of higher or ancestral level directories within the branch. Step 462 checks-in the latest version to commit or register that particular version in the target VOB directory so that it matches the source version. This step then checks-out the version in the parent directory from which the version was checked-out in the target VOB.

Step 464 moves the element(s) back into their original directory from the directory into which they were placed in step 444. Step 466 unchecks-out the latest version of the new subdirectory. The system works downward (recurses) from parent to offspring and each time it does that the parent is left checked-out. When the system finishes processing at the lowest offspring level it works back up, checking-in as it moves up to the preceding directories.

Prior to exiting a directory, in a finalization phase, the temporary subdirectory in the Target VOB's lost+found directory may be removed. Since the contents of this directory are all entries that also are linked elsewhere in the Target VOB nothing will remain in lost+found that requires further cleanup.

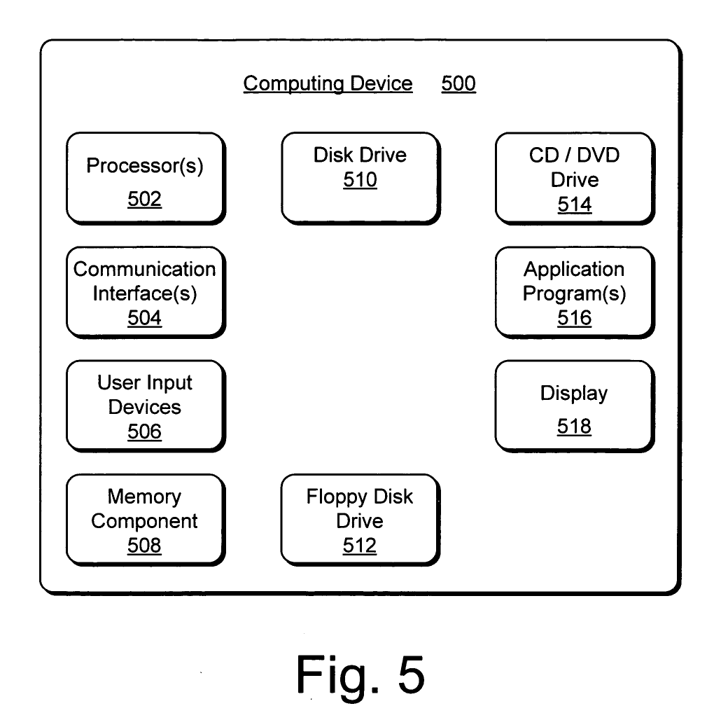

FIG. 5 illustrates various components of an exemplary computing device 500 that can be utilized with the inventive techniques described herein. Computing device 500 includes one or more processors 502, input/output communication interfaces 504 for the input and/or output of data, and user input devices 506. Processor(s) 502 can interact with the operating system 102 (described above in relation to FIG. 1) to process various instructions to control the operation of computing device 500. The communication interfaces 504 provide a mechanism for computing device 500 to communicate with other electronic and computing devices. User input devices 506 can include a keyboard, mouse, pointing device, and/or other mechanisms to interact with, and to input information to computing device 500.

Communication interfaces 504 can include serial, parallel, and/or network interfaces. A network interface allows devices coupled to a common data communication network to communicate information with computing device 500. Similarly, a serial and/or parallel interface provides a data communication path directly between computing device 500 and another electronic or computing device.

Computing device 500 also includes a memory component 508 (such as a ROM and/or a RAM), a disk drive 510, a floppy disk drive 512, and an optical disk drive 514 for reading from and/or writing to a removable, non-volatile optical disk 524 such as a CD-ROM, DVD-ROM, or other optical media. The memory components all provide data storage mechanisms for computing device 500.

Computing device 500 also includes application program(s) 516 and can include a display 518. Although not shown, a system bus typically connects the various components within computing device 500.

CONCLUSION

At least some of the embodiments described above can allow increased options in the source control management arena. Some of the described embodiments allow state and access to be maintained to data which may otherwise be inaccessible at various times during a product development process. These embodiments can allow data associated with a source VOB to be recreated in a target VOB. In some instances the data can comprise hard-links formed in the target VOB which correspond to hard-links which occur in the source VOB.

Although the inventive concepts have been described in language specific to structural features and/or methodological steps, it is to be understood that the inventive concepts in the appended claims are not limited to the specific features or steps described. Rather, the specific features and steps are disclosed as forms of implementing the inventive concepts.

1. A method comprising:
identifying data in a first version object base; and,
copying the data to a second version object base, wherein said act of copying comprises, at least in part, establishing a hard-link in the second version object base which corresponds to a hard-link in the first version object base.

2. The method as recited in claim 1, wherein said act of identifying comprises identifying a first element in the first version object base, the first element being associated with a first unique identification number.

3. The method as recited in claim 2, wherein said act of copying comprises creating a second element having a second unique identification number but otherwise being identical to the first element.

4. The method as recited in claim 1, wherein said act of copying comprises creating a second element in a first sub-directory of the second version object base which corresponds to the first element in the first version object base.

5. The method as recited in claim 4, wherein said act of establishing comprises obtaining a path to the second element in the second version object base via the unique identification number of the first element in the first version object base.

6. The method as recited in claim 5, wherein said act of establishing comprises obtaining a path to the second element in a first sub-directory of the second version object base from a second sub-directory of the second version object base.

7. The method as recited in claim 6, wherein said act of obtaining a path comprises:
checking-out a parent directory of the first sub-directory of the second version object base in which the second element resides;
moving the second element to a second sub-directory of the second version object base; and
unchecking-out the parent directory.

8. The method as recited in claim 6, wherein said act of obtaining a path comprises:
moving the second element to a second sub-directory of the second version object base;
setting a flag in the second sub-directory;
checking-in a latest version of the second sub-directory;
checking-out the latest version of the second sub-directory;
moving the second element back to the first sub-directory of the second version object base; and,
unchecking-out the latest version of the second sub-directory.

9. The method as recited in claim 8, wherein said act of setting comprises setting the flag in an object representing the second subdirectory.

10. A method comprising:
walking a source version object base; and,
maintaining state and access to elements that appear to have been removed from the source version object base.

11. The method of claim 10, wherein said act of maintaining comprises maintaining state and access to elements that appear to have been removed from versions of directories of the source version object base.

12. The method of claim 10, wherein said act of maintaining comprises copying data to a target version object base from the source version object base.

13. The method of claim 12, wherein said act of maintaining comprises establishing a link between a first parent directory of a target version object base and a second offspring directory of the target version object base.

14. The method of claim 12, wherein said act of copying data comprises copying data associated with a unique identification number.

15. The method of claim 14, wherein said act of copying comprises, upon encountering a first occurrence of the data associated with a specific unique identification number, copying the data in the second version object base, and upon subsequently encountering the data, creating a link to first occurrence.

16. A method comprising:
obtaining a path to an element in a target version object base via an element identification number associated with the element;
checking-out a parent directory of the element;
moving the element from a first subdirectory to a second subdirectory; and,
unchecking-out the parent directory.

17. The method of claim 16, wherein said act of moving comprises moving the element to a second sub-directory comprising a temporary holding subdirectory.

18. The method of claim 16, wherein said act of moving comprises moving the element to a second sub-directory comprising a lost+found subdirectory.

19. A method comprising:
walking a source version object base; and,
recreating elements of the source version object base in a target version object base, wherein said recreating comprises, at least in part, establishing hard-links in the target VOB.

20. The method of claim 19, wherein said act of recreating comprises forming multiple version object base sub-directories in the target version object base.

21. The method of claim 19 further comprising compiling a translation table of element identification numbers in the target version object base which correspond to element identification numbers in the source version object base.

22. A processing system comprising:
a first data storage media configured to store data associated with a first version object base;
a second data storage media configured to store data associated with a second version object base; and,
an application program configured to copy data from the first version object base to the second version object base and to cause at least some of the data associated with the second version object base to be stored in a temporary holding directory to maintain state and access to the data.

23. The system of claim 22, wherein the first data storage media and the second data storage media comprise two different data storage media.

24. The system of claim 22, wherein the temporary holding directory comprises a lost+found directory.

25. The system of claim 22, wherein the application is configured to form a hard-link in the second version object base which corresponds to a hard-link in the first version object base by accessing data in the temporary holding directory.
